(19) United States
(12) Patent Application Publication
(10) Pub. No.: US 2025/0357459 A1
(43) Pub. Date: Nov. 20, 2025

(54) EVALUATION APPARATUS AND EVALUATION METHOD FOR LITHIUM METAL BATTERY

(71) Applicants: Hyundai Motor Company, Seoul (KR); Kia Corporation, Seoul (KR)

(72) Inventors: Seongmin Ha, Hwaseong (KR); WonKeun Kim, Hwaseong (KR); Jongchan Song, Hwaseong (KR); JaeWook Shin, Hwaseong (KR); SeungJong Lee, Hwaseong (KR); Jihee Ham, Hwaseong (KR); Kyoung Han Yew, Hwaseong (KR); Areum Ha, Hwaseong (KR)

(21) Appl. No.: 18/887,523

(22) Filed: Sep. 17, 2024

(30) Foreign Application Priority Data
May 17, 2024 (KR) 10-2024-0064248

(51) Int. Cl. H01M 4/04; G01N 21/88; G01N 21/89; H01M 4/02; H01M 10/058; H01M 10/615; H01M 10/657

(52) U.S. Cl. CPC H01M 4/04; G01N 21/8851; G01N 21/8914; H01M 10/058; H01M 10/615; H01M 10/657; G01N 2021/8861; G01N 2021/8887; H01M 2004/027

(57) ABSTRACT

The disclosure relates to an evaluation system for lithium metal batteries, comprising a transport device for moving a lithium thin film with a lithium metal layer and a negative electrode current collector. An expansion device is used to form a defective portion on the film's surface by expanding a gas layer between the layers. A vision inspection device determines the defect, and a cutting device removes the defective portion. The system includes a controller that manages and adjusts the operations of these devices based on defect information, optimizing the process in real-time. The system enhances defect detection, precision, and efficiency in lithium metal battery production.

### CROSS-REFERENCE TO RELATED APPLICATION

This application claims under 35 U.S.C. § 119(a) the benefit of Korean Patent Application No. 10-2024-0064248 filed in the Korean Intellectual Property Office on May 17, 2024, the entire contents of which are incorporated herein by reference.

### BACKGROUND

### Technical Field

The disclosure relates to an evaluation apparatus and an evaluation method for a lithium metal battery, and more specifically, to an evaluation apparatus and an evaluation method for a lithium metal battery that can determine a bonding defect between a lithium metal layer and a negative electrode current collector.

### Background

The demand for alternative or clean energy is increasing as the use of fossil fuels continues to rise rapidly. Among the most actively studied areas in response to this demand are power generation and/or power storage fields that utilize electrochemical reactions.

A secondary battery is a representative example of an electrochemical device that utilizes such electrochemical energy, and the application of use thereof tends to be gradually expanding. With the recent technology development and increased demand for mobile devices such as portable computers and mobile phones and electric vehicles, the demand for secondary batteries as an energy source is rapidly increasing. Among the secondary batteries, research on lithium secondary batteries is underway, and the lithium secondary batteries are being widely commercialized.

Recently, the development of lithium metal batteries, a subset of lithium secondary batteries, has been actively pursued to achieve high energy density. The lithium metal battery is characterized in using a lithium metal as a negative electrode. To increase the energy density per volume or weight of such lithium metal batteries, it is necessary to reduce an amount of lithium metal used for the negative electrode to an appropriate level or less. To achieve this, a technique of disposing a lithium metal on a negative electrode current collector during driving for activating a battery using the negative electrode current collector is being used.

In the process of manufacturing a lithium thin film by bonding a lithium metal and a negative electrode current collector, insufficient adhesion between the lithium metal and the current collector can lead to defects in the lithium thin film. This, in turn, may result in an increased defect rate in the lithium metal battery.

The matters described in the background art section are prepared to enhance understanding of the background of the disclosure, and may include matters that have not been known to one skilled in the art to which the present technology belongs.

### SUMMARY OF THE DISCLOSURE

The present disclosure attempts to provide evaluation apparatus and an evaluation method for a lithium metal battery that can detect a defect in a lithium metal and a negative electrode current collector and reduce a defect rate of the lithium metal battery.

In some embodiments, an evaluation apparatus for a lithium metal battery includes a transport device for moving a lithium thin film that has a lithium metal layer and a negative electrode current collector. An expansion device may be used to expand a gas layer between the lithium metal layer and the current collector, forming a defective portion on the film's surface. A vision inspection device may determine the defective portion, and a cutting device may then remove it.

In some embodiments, the apparatus may include an induction heater within the expansion device to heat the lithium metal layer or the current collector. The induction heater may operate as a magnetic field generating induction heating device, an infrared laser heating device, or a radiation heating device. Alternatively, the expansion device may comprise an induction chamber to maintain the lithium thin film in a low vacuum state.

A controller may be included to manage the operations of the transport device, expansion device, vision inspection device, and cutting device. The controller may also adjust the transport speed and cutting timing based on defect information to ensure precise removal of the defective portion.

In some embodiments, an evaluation method for a lithium metal battery may involve transporting a lithium thin film with a transport device, expanding a gas layer to form a defective portion, determining defect information with a vision inspection device, and removing the defective portion using a cutting device.

The method may include heating the thin film to a specific temperature range during the expansion process or maintaining a low vacuum state in the expansion device. The method may also involve adjusting the transport speed and cutting timing based on the defect information.

In some embodiments, an evaluation system for a lithium metal battery may include similar components, with a controller that manages and adjusts operations based on real-time defect information. The system may use a roll-to-roll process for transporting the thin film and may include an induction heater that operates within set parameters to optimize defect formation. The vision inspection device may use a camera and image processor to analyze defects, and the cutting device may remove defects based on the vision inspection data. The controller may store defect information for optimizing future processing, and the induction chamber may maintain a low vacuum state to prevent oxidation. In addition, the effects that can be obtained or expected by the exemplary embodiments of the present disclosure will be directly or implicitly disclosed in the detailed description of the exemplary embodiments of the present disclosure. That is, various effects that may be expected by the exemplary embodiments of the present disclosure will be disclosed in the detailed description described below.

As discussed, the method and system suitably include use of a controller or processer.

In another embodiment, vehicles are provided that comprise an apparatus as disclosed herein.

### BRIEF DESCRIPTION OF THE DRAWINGS

Since the accompanying drawings are for reference in describing exemplary embodiments of the present disclosure, the technical spirit of the present disclosure should not be construed as being limited to the accompanying drawings.

FIG. 1 is a cross-sectional view showing a configuration of a lithium thin film including a lithium metal layer and a negative electrode current collector according to an exemplary embodiment.

FIG. 2 is a conceptual diagram showing a configuration of an evaluation apparatus for a lithium metal battery according to an exemplary embodiment.

FIG. 3 is a block diagram showing a configuration of an evaluation apparatus for a lithium metal battery according to an exemplary embodiment.

FIG. 4 is a flow chart showing an evaluation method for a lithium metal battery according to an exemplary embodiment.

FIG. 5A is a diagram for illustrating the initial stage of transporting a lithium thin film, which comprises a lithium metal layer and a negative electrode current collector, towards the expansion device for defect evaluation according to an exemplary embodiment.

FIG. 5B is a diagram illustrating the transport of the lithium thin film to the vision inspection device 30, which determines whether the film has a defect after reaching the set surface temperature according to an exemplary embodiment according to an exemplary embodiment.

FIG. 5C is a diagram for illustrating the determination of defect information by the vision inspection device, which captures and analyzes images of the lithium thin film to identify defective portions, after which the film is transported to the cutting device, according to an exemplary embodiment.

FIG. 5D is a diagram for illustrating the cutting process, where the cutting device removes the defective portion from the lithium thin film, ensuring that the defective portion is not included in the normal portion of the film, based on the defect information determined by the vision inspection device, according to an exemplary embodiment.

FIG. 6A is diagram showing the state of a lithium thin film with a bonded lithium metal layer and a negative electrode current collector after the expansion device expands the gas layer between them, forming a defective portion on the surface, according to an exemplary embodiment.

FIG. 6B is a diagram showing the state of a lithium thin film where the defective portion, such as a crater, becomes visible on the surface after the gas layer is expanded between the lithium metal layer and the negative electrode current collector by the expansion device, using either heat from the induction heater or a low vacuum state from the induction chamber, according to an exemplary embodiment.

FIG. 7 is a diagram for illustrating a computing device according to an exemplary embodiment.

It should be understood that the above-referenced drawings are not necessarily drawn to scale, and present rather simplified representations of various preferred features illustrating the basic principles of the present disclosure. The specific design features of the present disclosure, including, for example, specific dimensions, orientations, locations, and shapes, will be determined in part by the specific intended application and use environment.

### DETAILED DESCRIPTION OF THE EMBODIMENTS

The terminology used herein is for the purpose of describing specific exemplary embodiments only and is not intended to be limiting the present disclosure. As used herein, the singular forms are intended to include the plural forms as well, unless the context clearly indicates otherwise. It will be further understood that the terms “comprises” and/or “comprising”, when used in the present specification, specify the presence of stated features, integers, steps, operations, constitutional elements, and/or components, but do not preclude the presence or addition of one or more other features, integers, steps, operations, constitutional elements, components, and/or groups thereof. As used herein, the term “and/or” includes any one or all combinations of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Additionally, it is understood that one or more of the methods or aspects thereof below may be executed by at least one or more controllers 50. The term “controller 50” may refer to a hardware device that includes a memory and a processor. The memory is configured to store program instructions and the processor is specially programmed to execute the program instructions so as to perform one or more processes described in more detail below. The controller 50, as described herein, may control operations of units, modules, components, devices, or the like. It is also understood that the methods below may be executed by a device that includes the controller 50 along with one or more other components, as will be appreciated by one skilled in the art.

Additionally, the controller 50 of the present disclosure may be implemented as a non-transitory computer-readable recording medium containing executable program instructions executed by a processor. Examples of the computer-readable recording medium include a ROM, a RAM, a compact disk (CD) ROM, magnetic tapes, floppy disks, flash drives, smart cards, and optical data storage devices, but are not limited thereto. The computer-readable recording medium may also be distributed throughout a computer network so that program instructions may be stored and executed in a distributed manner, for example, on a telematics server or a controller area network (CAN).

In the following detailed description, only certain exemplary embodiments of the present disclosure have been shown and described, simply by way of illustration. However, the present disclosure can be variously implemented and is not limited to the following exemplary embodiments.

The drawings and description are to be regarded as illustrative in nature and not restrictive. Like reference numerals designate like elements throughout the specification.

In addition, the size and thickness of each configuration shown in the drawings are arbitrarily shown for understanding and ease of description, but the present disclosure is not limited thereto. In the drawings, the thickness of portions, films, panels, regions, etc., are exaggerated for clarity.

The suffixes “module” and/or “unit” or “part” for constitutional elements used in the following description are given or used interchangeably only for ease of writing the specification, and thus do not themselves have distinct meanings or roles.

In addition, in describing an exemplary embodiment disclosed, a detailed description of related known technologies will be omitted if it is determined that the detailed description makes the gist of the exemplary embodiment of the present specification unclear.

Further, the accompanying drawings are provided for helping to easily understand exemplary embodiments disclosed in the present specification, and the technical spirit disclosed in the present specification is not limited by the accompanying drawings, and it will be appreciated that the present invention includes all of the modifications, equivalent matters, and substitutes included in the spirit and the technical scope of the present disclosure.

Terms including an ordinary number, such as first and second, are used for describing various constituent elements, but the constituent elements are not limited by the terms.

In the following description, expressions described in singular can be interpreted as singular or plural unless explicit expressions such as “one” or “single” are used.

The terms are used only to discriminate one constituent element from another constituent element.

In the flowchart described with reference to the drawings in this specification, the order of the operations may be changed, several operations may be merged, certain operations may be divided, and specific operations may not be performed.

First, a structure of a lithium metal battery according to an exemplary embodiment will be briefly described.

A lithium metal battery may include a positive electrode, a negative electrode, a separator positioned between the positive electrode and the negative electrode, and an electrolyte impregnated in the separator.

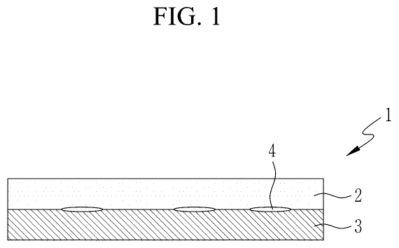

FIG. 1 is a cross-sectional view showing a configuration of a lithium thin film including a lithium metal layer and a negative electrode current collector according to an exemplary embodiment.

Referring to FIG. 1, a negative electrode of a lithium metal battery according to an exemplary embodiment may include a lithium metal layer 2 and a negative electrode current collector 3.

The negative electrode current collector 3 may include copper (Cu), and the negative electrode current collector 3 may be a copper foil. When the negative electrode current collector 3 is made of copper, it has excellent electrochemical stability in a lithium secondary battery and has high electrical conductivity. Therefore, it is possible to have uniform current distribution in the negative electrode, making it easy to implement a large-area battery. Furthermore, the negative electrode current collector 3 made of copper has excellent mechanical strength and cracks and deformation can be minimized during repeated charging and discharging.

Alternatively, the negative electrode current collector 3 may include a base material, and copper may be coated on the base material. Copper may cover at least part of a surface of the base material, or may cover the entire surface of the base material.

The negative electrode current collector 3 may be bonded to the lithium metal layer 2 through lamination to form a lithium thin film 1.

Hereinafter, an evaluation apparatus for a lithium metal battery according to an exemplary embodiment will be described in detail with reference to the accompanying drawings.

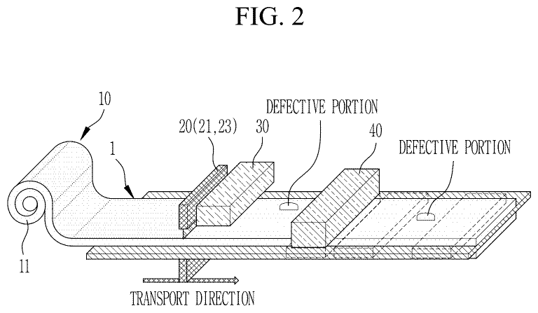

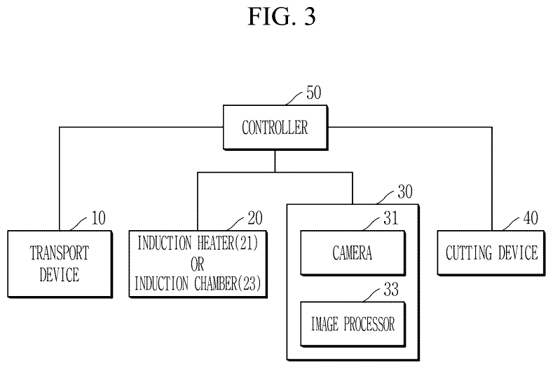

FIG. 2 is a conceptual diagram showing a configuration of an evaluation apparatus for a lithium metal battery according to an exemplary embodiment. FIG. 3 is a block diagram showing a configuration of an evaluation apparatus for a lithium metal battery according to an exemplary embodiment.

As shown in FIGS. 2 and 3, the evaluation apparatus for a lithium metal battery according to an exemplary embodiment may include a transport device 10, an expansion device 20, a vision inspection device 30, a cutting device 40, and a controller 50.

The transport device 10 may transport the lithium thin film 1, in which the lithium metal layer 2 and the negative electrode current collector 3 are bonded, in a set direction. The transport device 10 may mount the lithium thin film 1 thereon and transport the same to the expansion device 20. The transport device 10 may be implemented in a roll-to-roll manner. For example, the transport device 10 may include a supply roller 11 on which the lithium thin film is wound, and the lithium thin film 1 may be transported as the supply roller 11 rotates.

In a process of manufacturing the lithium thin film 1 by bonding the lithium metal and the negative electrode current collector 3, if a void occurs due to insufficient adhesion between the lithium metal and the negative electrode current collector 3, gas flows into the void between the lithium metal and the negative electrode current collector 3. Gas may flow into the void between the lithium metal and the negative electrode current collector 3 to form a gas layer 4.

The expansion device 20 may expand the gas layer 4 between the lithium metal and the negative electrode current collector 3. When the gas layer 4 is expanded by the expansion device 20, a defective portion such as a crater is formed on a surface of the lithium thin film 1.

To this end, the expansion device 20 may include an induction heater 21 that heats the lithium metal layer 2 or negative electrode current collector 3 of the lithium thin film 1 of the lithium metal layer 2 and the negative electrode current collector 3. The expansion device 20 may be implemented by at least one of a magnetic field generating induction heating device, an infrared laser heating device, and a radiation heating device.

The induction heater 21 may have a set frequency range (for example, 1 MHz to 2 GHz) and a set output range (for example, 1 mW to 1 kW), and operate for a set time range (for example, 0.1 second to 10 minutes). In this case, a surface temperature of the lithium metal layer 2 may be set between 60° C. and 100° C.

At least one induction heater 21 may be provided depending on an area of the lithium thin film 1 to be transported. Alternatively, when the negative electrode current collector 3 is disposed on both surfaces of the lithium metal layer 2, the induction heaters 21 may be provided on both sides of the lithium thin film 1.

While the lithium thin film 1 transported by the transport device 10 passes through the induction heater 21, the gas layer 4 between the lithium metal layer 2 and the negative electrode current collector 3 of the lithium thin film 1 expands by heat, and the expanded gas layer 4 pushes up the lithium thin film 1 with relatively greater ductility. Accordingly, a crater is formed on the surface of the lithium thin film 1. The crater formed on the surface of the lithium thin film 1 is a defective portion of the lithium thin film 1, and the defective portion formed on the surface of the lithium thin film 1 can be confirmed with the naked eye or the vision inspection device 30. With this, it is possible to determine whether the lithium thin film 1 is defective.

The expansion device 20 of the evaluation apparatus for a lithium metal battery according to an exemplary embodiment may include an induction chamber 23 that maintains the lithium thin film 1 to be in a low vacuum state. The induction chamber 23 may be disposed in close contact with one or both surfaces of the lithium thin film 1.

The lithium thin film 1 may be maintained in a low vacuum state within a set pressure range (for example, 100 to 10⁻³ mbar) by the induction chamber 23 and operate for a set time (for example, 1 second to 10 minutes).

While the lithium thin film 1 transported by the transport device 10 passes through the induction chamber 23, the gas layer 4 between the lithium metal layer 2 and the negative electrode current collector 3 of the lithium thin film 1 expands due to the low vacuum, and the expanded gas layer 4 pushes up the lithium thin film 1 with relatively greater ductility. Accordingly, a crater is formed on the surface of the lithium thin film 1. The crater formed on the surface of the lithium thin film 1 is a defective portion of the lithium thin film 1 and can be confirmed with the naked eye or the vision inspection device 30.

When the induction chamber 23 is used as the expansion device 20, oxidation of the lithium thin film 1 by heat can be suppressed compared to a case where the induction heater 21 is used as the expansion device 20.

The vision inspection device 30 may determine the defective portion formed as a result of expansion by the expansion device 20. The vision inspection device 30 may be provided downstream of the expansion device 20.

The vision inspection device 30 may determine defect information including the number of defective portions, a shape of the defective portion, and a size of the defective portion, and the defect information determined by the vision inspection device 30 may be transmitted to the controller 50.

The vision inspection device 30 may include a camera 31 that captures a surface of the lithium thin film 1, and an image processor 33 that performs vision processing on an image captured by the camera 31. The image processor 33 may perform vision processing on the image captured by the camera 31 to determine the defect information on the lithium thin film 1, and the determined defect information may be transmitted to the controller 50.

The cutting device 40 may cut the lithium thin film 1 to a set size with excluding the defective portion of the lithium thin film 1. The cutting device 40 may be provided downstream of the vision inspection device 30. The cutting device 40 may include a cutter that cuts the lithium thin film 1.

The controller 50 may remove the defective portion of the lithium thin film 1 determined by the vision inspection device 30 by the cutting device 40. To this end, the controller 50 may control a transport speed of the lithium thin film 1 by the transport device 10 and a cutting timing of the lithium thin film 1 by the cutting device 40.

The controller 50 may control an overall operation of the transport device 10, the vision inspection device 30, and the cutting device 40.

To this end, the controller 50 may be implemented by one or more processors that operate according to a set program, and the memory of the controller 50 stores program instructions programmed to execute each step of an evaluation method for a lithium metal battery according to the present disclosure by one or more processors.

Hereinafter, an evaluation method for a lithium metal battery according to an exemplary embodiment will be described in detail with reference to the accompanying drawings.

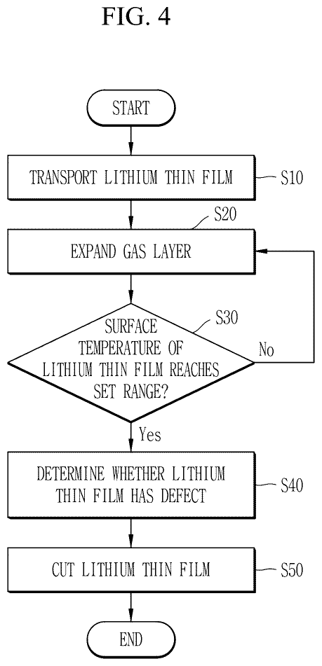

FIG. 4 is a flow chart showing an evaluation method for a lithium metal battery according to an exemplary embodiment.

Referring to FIG. 4, the controller 50 may transport the lithium thin film 1 including the lithium metal layer 2 and the negative electrode current collector 3 to the expansion device 20 by the transport device 10 (S10). A transport speed of the lithium thin film 1 transported by the transport device 10 may be adjusted by the controller 50.

When the lithium thin film 1 reaches the expansion device 20, the controller 50 may determine whether the expansion device 20 is ready to expand the lithium thin film 1.

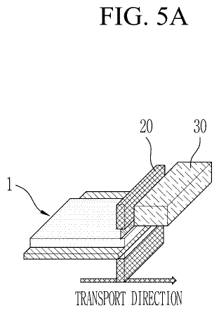

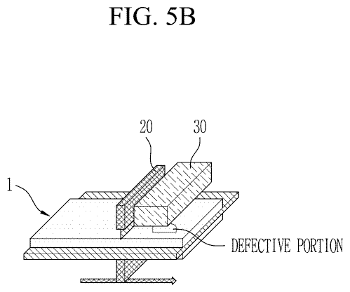

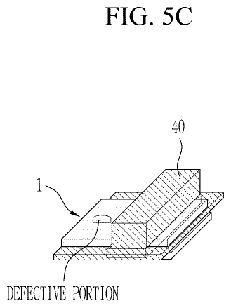

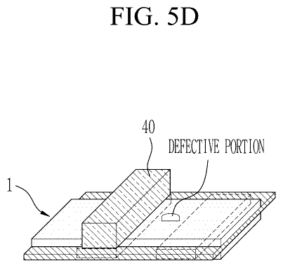

When the lithium thin film 1 reaches the expansion device 20 and the expansion device 20 is ready for operation, the controller 50 may expand the gas layer 4 in the lithium thin film 1 by the expansion device 20 (S20) (see FIG. 5A).

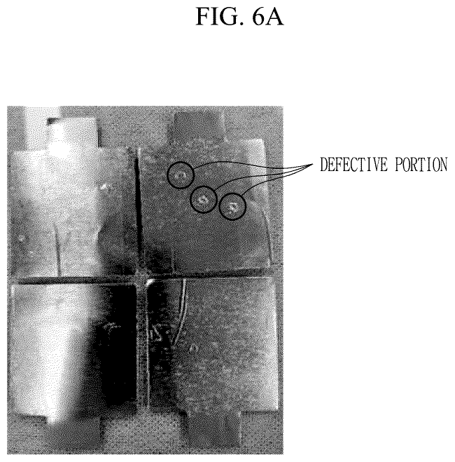

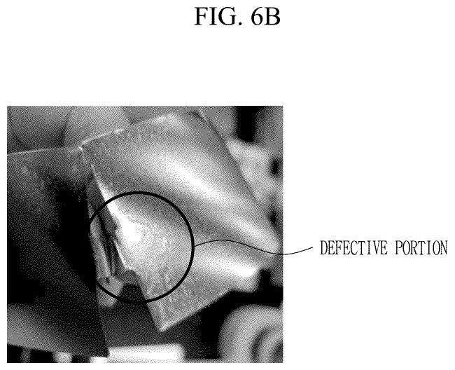

For example, the controller 50 may heat the lithium thin film 1 by the induction heater 21 until the lithium thin film reaches a set temperature. Alternatively, the controller 50 may maintain the lithium thin film 1 to be in a low vacuum state for a set time by the induction chamber 23. That is, the expansion device 20 may expand the gas layer 4 between the lithium metal layer 2 and the negative electrode current collector 3 to form a defective portion (for example, a crater, or the like) on the surface of the lithium thin film 1 (see FIGS. 6A and 6B).

When the expansion device 20 is the induction heater 21, the controller 50 may adjust a distance between the induction heater 21 and the lithium thin film 1, a frequency range of the induction heater 21, an output range of the induction heater 21, and a heating time of the induction heater 21.

Alternatively, when the expansion device 20 is the induction chamber 23, the controller 50 may bring the induction chamber 23 into close contact with the lithium thin film 1 and control the lithium thin film 1 to be maintained in a low vacuum state. In this case, the controller 50 may adjust a pressure of the induction chamber 23 and a time for which the lithium thin film 1 is maintained in a low vacuum state by the induction chamber 23.

The controller 50 may determine whether the surface temperature of the lithium thin film 1 has reached the set temperature (S30).

When the expansion device 20 is the induction heater 21, if the surface temperature of the lithium thin film 1 does not reach the set temperature range (for example, 60° C. to 100° C.), the controller 50 heats the lithium thin film 1 by the induction heater 21 until the surface temperature of the lithium thin film 1 reaches the set temperature range. When the surface temperature of the lithium thin film 1 reaches the set temperature range, the controller 50 stops heating the lithium thin film 1 by the induction heater 21.

Alternatively, when the expansion device 20 is the induction chamber 23, if the time for which the lithium thin film 1 is maintained in a low vacuum state does not reach the set time, the controller 50 maintains the low vacuum state of the lithium thin film 1 by the induction chamber 23 until the time for which the lithium thin film 1 is maintained in a low vacuum state reaches the set time. When the time for which the lithium thin film 1 is maintained in a low vacuum state by the induction chamber 23 reaches the set time, the controller 50 ends maintaining the lithium thin film 1 in the low vacuum state.

When the surface temperature of the lithium thin film 1 reaches the set temperature, the lithium thin film 1 is transported to the vision inspection device 30 by the transport device 10, and the vision inspection device 30 may determine whether the lithium thin film 1 has a defect (S40) (see FIG. 5B).

In this case, the vision inspection device 30 captures the surface of the lithium thin film 1 by the camera 31, and the captured image may be used to determine whether the lithium thin film 1 has a defect by the image processor 33. The vision inspection device 30 may transmit defect information including the number of defective portions of the lithium thin film 1, a shape of the defective portion, and a size of the defective portion to the controller 50.

When it is determined whether the lithium thin film 1 has a defect by the vision inspection device 30, the lithium thin film 1 is transported to the cutting device 40 by the transport device 10, and the cutting device 40 may cut the lithium thin film 1 so that the defective portion is not included in a normal portion of the lithium thin film 1 (S50) (see FIGS. 5C and 5D).

The controller 50 may adjust the transport speed of the lithium thin film 1 by the transport device 10 and the cutting timing of the lithium thin film 1 by the cutting device 40 so that the lithium thin film 1 can be cut by distinguishing between normal and defective portions of the lithium thin film 1.

Expressed differently, the controller 50 may adjust the transport speed of the lithium thin film 1 by the transport device 10 and the cutting timing of the lithium thin film 1 by the cutting device 40 based on the defect information about the defective portion of the lithium thin film 1.

That is, the controller 50 may cut the lithium thin film 1 by the cutting device 40 so that the defective portion is not included in the normal portion of the lithium thin film 1.

As described above, according to the evaluation apparatus and method for a lithium metal battery of an exemplary embodiment, the gas layer 4 included in the lithium thin film 1 may be expanded using the expansion device 20 (the induction heater 21 or the induction chamber 23) to form the defective portion such as a crater on the surface of the lithium thin film 1. By confirming the defective portion formed in the lithium thin film 1 using the vision inspection device 30 and cutting the lithium thin film 1 by distinguishing between normal and defective portions, an occurrence of defects in the lithium metal battery can be minimized.

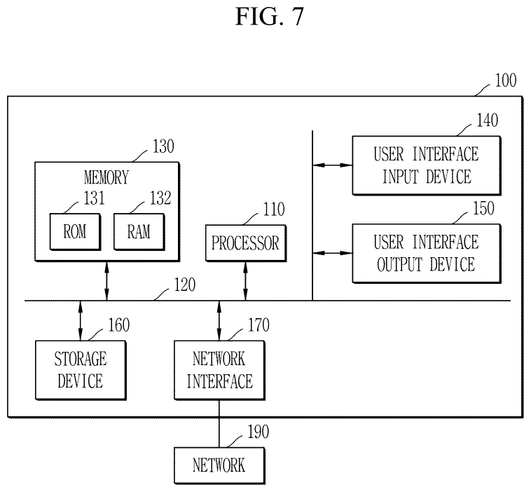

FIG. 7 is a diagram for illustrating a computing device according to an exemplary embodiment.

Referring to FIG. 7, an evaluation method for a lithium metal battery according to an exemplary embodiment may be implemented using a computing device 100.

The computing device 100 may include at least one of a processor 110, a memory 130, a user interface input device 140, a user interface output device 150, and a storage device 160 that communicate over a bus 120. The computing device 100 may also include a network interface 170 that is electrically connected to a network 190. The network interface 170 may transmit or receive signals to and from other entities via the network 190.

The processor 110 may be implemented in various types such as a micro controller unit (MCU), an application processor (AP), a central processing Unit (CPU), a graphic processing unit (GPU), and a neural processing unit (NPU), and may be any semiconductor device that executes instructions stored in the memory 130 or storage device 160. The processor 110 may be configured to implement the functions and methods described above in connection with FIGS. 1 and 6.

The memory 130 and the storage device 160 may include various types of volatile or non-volatile storage media. For example, the memory may include a read-only memory (ROM) 131 and a random access memory (RAM) 132. In the present exemplary embodiment, the memory 130 may be located inside or outside the processor 110, and the memory 130 may be connected to the processor 110 through various known means.

In some exemplary embodiments, at least some configurations or functions of the evaluation apparatus and method for a lithium metal battery according to the exemplary embodiments may be implemented by a program or software running on the computing device 100, and the program or software may be stored on a computer-readable medium.

In some exemplary embodiments, at least some configurations or functions of the evaluation method for a lithium metal battery according to the exemplary embodiments may be implemented using hardware or circuitry of the computing device 100, or may be implemented using separate hardware or circuitry that can be electrically connected to the computing device 100.

While the present disclosure has been described in connection with what is presently considered to be practical exemplary embodiments, it is to be understood that the present disclosure is not limited to the disclosed exemplary embodiments. On the contrary, it is intended to cover various modifications and equivalent arrangements included within the spirit and scope of the appended claims.

### DESCRIPTION OF SYMBOLS

1: lithium thin film
2: lithium metal layer
3: negative electrode current collector
4: gas layer
10: transport device
20: expansion device
21: induction heater
23: induction chamber
30: vision inspection device
31: camera
33: image processor
40: cutting device
50: controller

What is claimed is:

1. An evaluation apparatus for a lithium metal battery, comprising:
a transport device configured to transport a lithium thin film comprising a lithium metal layer and a negative electrode current collector;
an expansion device configured to expand a gas layer formed between the lithium metal layer and the negative electrode current collector to form a defective portion on a surface of the lithium thin film;
a vision inspection device configured to determine the defective portion; and
a cutting device configured to remove the defective portion of the lithium thin film.

2. The evaluation apparatus for a lithium metal battery of claim 1, wherein the expansion device comprises an induction heater configured to heat the lithium metal layer or the negative electrode current collector.

3. The evaluation apparatus for a lithium metal battery of claim 2, wherein the induction heater is at least one of a magnetic field generating induction heating device, an infrared laser heating device, and a radiation heating device.

4. The evaluation apparatus for a lithium metal battery of claim 1, wherein the expansion device comprises an induction chamber configured to maintain the lithium metal layer or the negative electrode current collector to be in a low vacuum state.

5. The evaluation apparatus for a lithium metal battery of claim 1, further comprising a controller configured to control operations of the transport device, the expansion device, the vision inspection device, and the cutting device.

6. The evaluation apparatus for a lithium metal battery of claim 5, wherein the controller is configured to cut the lithium thin film using the cutting device so that the defective portion is not included in a normal portion of the lithium thin film.

7. The evaluation apparatus for a lithium metal battery of claim 6, wherein the controller is configured to adjust a transport speed of the lithium thin film by the transport device and a cutting timing of the lithium thin film by the cutting device based on defect information about the defective portion determined by the vision inspection device.

8. An evaluation method for a lithium metal battery, comprising:
transporting a lithium thin film comprising a lithium metal layer and a negative electrode current collector by a transport device;
expanding a gas layer formed between the lithium metal layer and the negative electrode current collector to form a defective portion on a surface of the lithium thin film by an expansion device;
determining defect information about the defective portion formed on the surface of the lithium thin film by a vision inspection device; and
cutting the lithium thin film by a cutting device to remove the defective portion.

9. The evaluation method for a lithium metal battery of claim 8, wherein in the forming the defective portion, the lithium thin film is heated by the expansion device until a surface temperature of the lithium thin film reaches a set temperature range.

10. The evaluation method for a lithium metal battery of claim 8, wherein in the forming the defective portion, a low vacuum state of the lithium thin film is maintained for a set time by the expansion device.

11. The evaluation method for a lithium metal battery of claim 8, wherein in the cutting, a transport speed of the lithium thin film by the transport device and a cutting timing of the lithium thin film by the cutting device are adjusted based on the defect information about the defective portion.

12. An evaluation system for a lithium metal battery, comprising:
a transport device configured to transport a lithium thin film comprising a lithium metal layer and a negative electrode current collector;
an expansion device configured to expand a gas layer formed between the lithium metal layer and the negative electrode current collector to form a defective portion on a surface of the lithium thin film;
a vision inspection device configured to determine the defective portion;
a cutting device configured to remove the defective portion of the lithium thin film; and
a controller configured to control the operations of the transport device, the expansion device, the vision inspection device, and the cutting device, adjusting the operation parameters based on defect information determined by the vision inspection device.

13. The evaluation system for a lithium metal battery of claim 12, wherein the transport device comprises a supply roller and a take-up roller, and the lithium thin film is transported between these rollers in a roll-to-roll process.

14. The evaluation system for a lithium metal battery of claim 12, wherein the expansion device comprises an induction heater configured to heat the lithium metal layer or the negative electrode current collector.

150. The evaluation system for a lithium metal battery of claim 14, wherein the induction heater operates within a set frequency range and output range to optimize the expansion of the gas layer.

16. The evaluation system for a lithium metal battery of claim 12, wherein the vision inspection device includes a camera and an image processor configured to capture and analyze images of the lithium thin film surface to determine defect information.

17. The evaluation system for a lithium metal battery of claim 12, wherein the cutting device is configured to remove the defective portion of the lithium thin film based on the defect information provided by the vision inspection device.

18. The evaluation system for a lithium metal battery of claim 12, wherein the controller is further configured to adjust the transport speed of the lithium thin film based on real-time defect information to ensure precise cutting.

19. The evaluation system for a lithium metal battery of claim 12, wherein the controller stores defect information and uses it to optimize future processing parameters.

20. The evaluation system for a lithium metal battery of claim 12, wherein the induction chamber maintains the lithium thin film in a low vacuum state to prevent oxidation during the expansion process.
